(19) United States
(12) Patent Application Publication
(10) Pub. No.: US 2026/0061753 A1
(43) Pub. Date: Mar. 5, 2026

(54) INK REPLENISHMENT CONTAINER

(71) Applicant: SEIKO EPSON CORPORATION, Tokyo (JP)

(72) Inventors: Yuta KOIKE, Matsumoto-shi (JP); Tadahiro Mizutani, Shiojiri-shi (JP); Tadashi Watanabe, Matsumoto-shi (JP); Atsushi Kobayashi, Matsumoto-shi (JP); Shun Oya, Kiso-machi (JP)

(73) Assignee: SEIKO EPSON CORPORATION, Tokyo (JP)

(21) Appl. No.: 19/318,732

(22) Filed: Sep. 4, 2025

(30) Foreign Application Priority Data
Sep. 5, 2024 (JP) 2024-153150

(51) Int. Cl. B41J 2/175

(52) U.S. Cl. CPC B41J 2/17596

(57) ABSTRACT

An ink replenishment container comprises an outlet valve unit including a seal member that includes a first seal portion at least partially in contact with a side surface of an ink introduction member in a valve-opened state. The first seal portion is an annular protrusion having a minimum inner diameter portion in a first radial direction. The protrusion has a height from a second direction-side inner peripheral surface of the inner peripheral surface to the minimum inner diameter portion. When a position of an end of the minimum inner diameter portion in the second direction is defined as a boundary, a portion on a first direction side from the boundary is defined as an outlet-side portion, and a portion on the second direction side from the boundary is defined as a valve body-side portion, the valve body-side portion is smaller in volume than the outlet-side portion.

The present application is based on, and claims priority from JP Application Serial Number 2024-153150, filed Sep. 5, 2024, the disclosure of which is hereby incorporated by reference herein in its entirety.

### BACKGROUND

### 1. Technical Field

The present disclosure relates to an ink replenishment container.

### 2. Related Art

JP-A-2023-43905 discloses an ink replenishment container that replenishes an ink tank of a printer with ink via an ink inlet flow path member that communicates with the ink tank. The ink replenishment container includes an ink outlet forming portion including a tubular portion having an ink outlet. An outlet valve unit is mounted in the tubular portion. When a user mounts the ink replenishment container to the printer, the ink inlet flow path member is inserted into the ink outlet, the outlet valve unit is opened, and the ink tank is replenished with the ink. In the valve-open state, a substantially ring-shaped seal member forming a part of the outlet valve unit comes into contact with an outer peripheral surface of the ink inlet flow path member, thereby sealing the outer peripheral surface of the ink inlet flow path member. An inner surface of the seal member protrudes inward so as to interfere with the outer peripheral surface of the ink inlet flow path member.

When an interference volume between an ink introduction member inserted into an ink outlet of an ink replenishment container and a seal member in contact with an outer peripheral surface of the ink introduction member is large, a load when the ink replenishment container is coupled to the ink introduction member increases. Therefore, there is room for improvement of the ink replenishment container in terms of ease of coupling.

### SUMMARY

According to a first aspect of the present disclosure, an ink replenishment container is provided. The ink replenishment container replenishes an ink tank of a printer with ink via an ink introduction member communicating with the ink tank. The ink replenishment container includes a container main body configured to accommodate the ink, an ink outlet forming portion connected to the container main body and including a tubular portion forming an outlet on an opposite side from the container main body, and an outlet valve unit mounted in the ink outlet forming portion and configured to be opened by the ink introduction member inserted into the tubular portion from the outlet and to be closed by removal of the ink introduction member from the tubular portion. The outlet valve unit includes a valve body disposed to be movable in a central axis direction along a central axis of the tubular portion, a spring member configured to bias the valve body in a first direction toward the outlet side in the central axis direction, and a seal member located on the outlet side from the valve body in the central axis direction, the seal member having a through-hole through which the ink introduction member is inserted and removed, in a valve-opened state, a gap through which the ink and the air communicate being formed between the seal member and the valve body that is pressed by the ink introduction member, which is inserted through the through-hole, in a second direction opposite to the first direction, in a valve-closed state, the valve body being in contact with the sealing member and the through-hole being closed by removal of the ink introduction member through the through-hole. The seal member includes a first seal portion on an inner peripheral surface forming the through-hole, the first seal portion being at least partially in contact with a side surface of the ink introduction member inserted into the through-hole in the valve-opened state to seal the side surface of the ink introduction member. The first seal portion is an annular protruding portion having a minimum inner diameter portion in a first radial direction toward the central axis, in a radial direction orthogonal to the central axis direction. The protruding portion has a height from a second direction-side inner peripheral surface of the inner peripheral surface to the minimum inner diameter portion in the first radial direction, the second direction-side inner peripheral surface located on the second direction side from the protruding portion. The seal member is formed such that in the protruding portion a volume of a valve body-side portion is smaller than a volume of an outlet-side portion, the valve body-side portion being a portion located on the second direction side with respect to a boundary, the outlet-side portion being a portion located on the first direction side with respect to the boundary, the boundary being a position of an end portion of the minimum inner diameter portion in the second direction.

### BRIEF DESCRIPTION OF THE DRAWINGS

FIG. 1 is a perspective view of a printer.

FIG. 2 is a perspective view of an ink tank.

FIG. 3 is a perspective view showing a replenishment state in which the ink tank is replenished with ink from an ink replenishment container.

FIG. 4 is an exploded perspective view of the ink replenishment container.

FIG. 5 is a partial sectional view of the ink replenishment container in a non-replenishment state in which the ink tank is not replenished with ink.

FIG. 6 is an enlarged view of a part of FIG. 5.

FIG. 7 is a partial sectional view of the ink replenishment container and the ink tank in a replenishment state in which the ink tank is replenished with ink.

FIG. 8 is an enlarged view of a part of FIG. 7.

FIG. 9 is a perspective view of an outlet valve unit.

FIG. 10 is a view showing a configuration of a valve body.

FIG. 11 is a view showing a part of a cross section of a seal member cut along a central axis of a tubular portion.

FIG. 12 is a view for describing deformation of a first seal portion when an ink introduction member is inserted into a through-hole.

FIG. 13 is a view for describing deformation of the first seal portion when the ink introduction member is removed from the through-hole.

FIG. 14 is a view for describing a shape of a seal member in a second embodiment.

FIG. 15 is a view showing a part of a cross section of a seal member cut along a central axis of a tubular portion in another embodiment.

### DESCRIPTION OF EMBODIMENTS

### A. First Embodiment

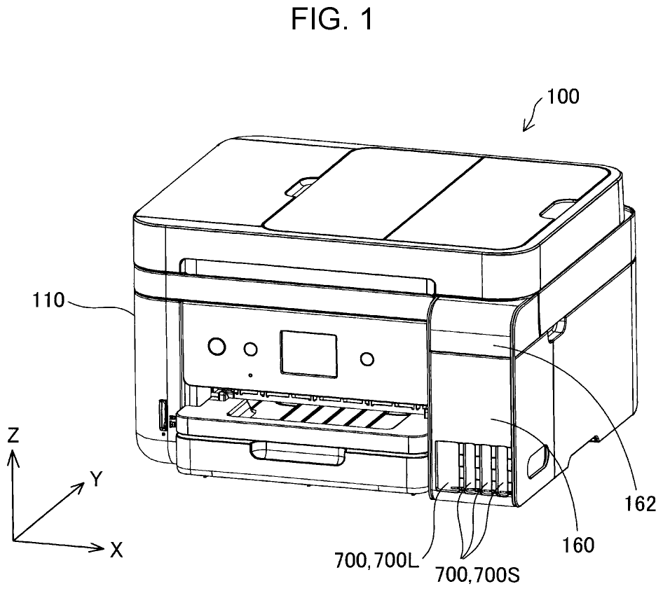

FIG. 1 is a perspective view of a printer 100. FIG. 1 shows XYZ axes that are three spatial axes orthogonal to each other. Directions in which arrows of an X-axis, a Y-axis, and a Z-axis are directed indicate positive directions along the X-axis, the Y-axis, and the Z-axis, respectively. The positive directions along the X-axis, the Y-axis, and the Z-axis are respectively referred to as a +X direction, a +Y direction, and a +Z direction. Directions opposite to the directions in which the arrows of the X-axis, the Y-axis, and the Z-axis are directed are negative directions along the X-axis, the Y-axis, and the Z-axis, respectively. The negative directions along the X-axis, the Y-axis, and the Z-axis are respectively referred to as a −X direction, a −Y direction, and a −Z direction. The directions along the X-axis, the Y-axis, and the Z-axis, regardless of positive or negative, are referred to as an X direction, a Y direction, and a Z direction, respectively.

In the present embodiment, in a use state of the printer 100, the X-axis and the Y-axis are axes along a horizontal plane, and the Z-axis is an axis along a gravity direction. In the following, the gravity direction is the −Z direction, and an anti-gravity direction is the +Z direction. In addition, a direction from a rear surface side to a front surface side of the printer 100 is the −Y direction, and a direction from the front surface side to the rear surface side is the +Y direction. In addition, when the printer 100 is viewed from the front surface side, a direction from a right side to a left side is the −X direction, and a direction from the left side to the right side is the +X direction. The “use state of the printer 100” refers to a state in which the printer 100 is installed on the horizontal plane. The same applies to the following drawings and descriptions.

The printer 100 is an ink jet printer that ejects ink onto a print medium and performs printing. The printer 100 includes a housing 110. A carriage (not shown) is provided inside the housing 110. The carriage is movable in a main scanning direction along the X direction. A print head (not shown) that ejects the ink onto the print medium is installed on the carriage. An ink tank accommodating unit 160 is provided at one end of a front surface of the housing 110. The ink tank accommodating unit 160 accommodates a plurality of ink tanks 700S and 700L. The ink tank accommodating unit 160 has an openable/closable lid 162 on an upper portion thereof. A first ink tank 700S is a tank having a small capacity. A second ink tank 700L is a tank having a large capacity. In the following description, both are simply referred to as an “ink tank 700” without distinction. The ink tank 700 is coupled to the print head of the carriage by a tube (not shown). That is, the ink tank 700 is a stationary ink tank that is not mounted on the carriage of the printer 100. The ink tank 700 may be mounted on the carriage of the printer 100.

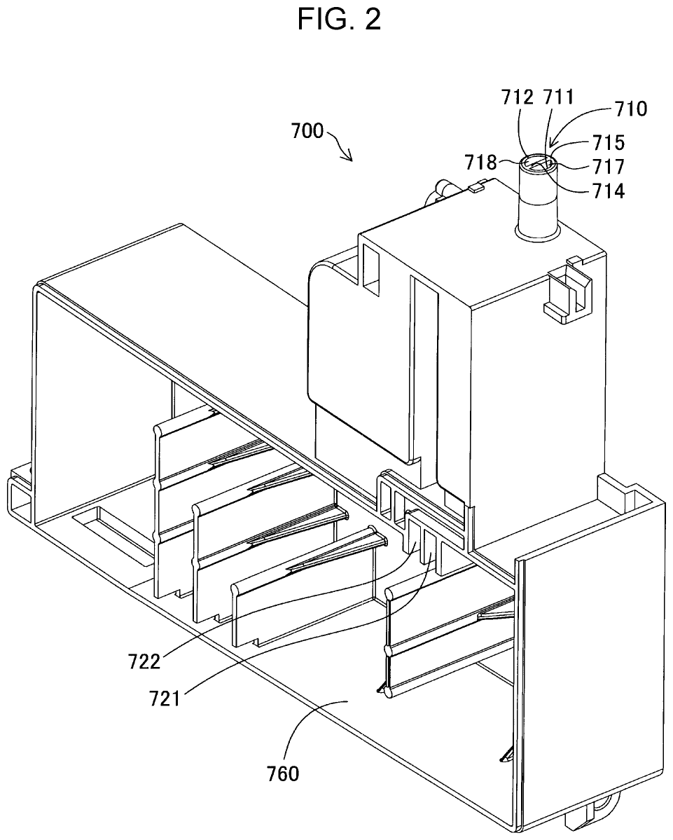

FIG. 2 is a perspective view of the ink tank 700. An ink introduction member 710 is provided on an upper surface of the ink tank 700. The ink introduction member 710 is a tubular member for replenishing the ink tank 700 with the ink. An outer diameter of the ink introduction member 710 is constant regardless of a position of the ink introduction member 710 in an axial direction. The ink introduction member 710 protrudes upward from the ink tank 700. The ink introduction member 710 has a plurality of introduction flow paths 711 and 712 partitioned by a partition 714. In the present embodiment, the ink introduction member 710 has two introduction flow paths 711 and 712. The two introduction flow paths 711 and 712 communicate with two in-tank flow paths 721 and 722, respectively, protruding into an ink accommodating chamber 760 of the ink tank 700. The two introduction flow paths 711 and 712 have opening end surfaces 717 and 718, respectively, as an opening formed in a tip end surface 715 of the ink introduction member 710. An opening end area, which is each area of the opening end surfaces 717 and 718, is uniform in the two introduction flow paths 711 and 712. A part of the tip end surface 715 of the ink introduction member 710 corresponds to an end portion of the partition 714. In the outer diameter of the ink introduction member 710, it is sufficient that the outer diameter of the portion to be inserted into the ink replenishment container 200 described later is constant regardless of the position of the ink introduction member 710 in the axial direction.

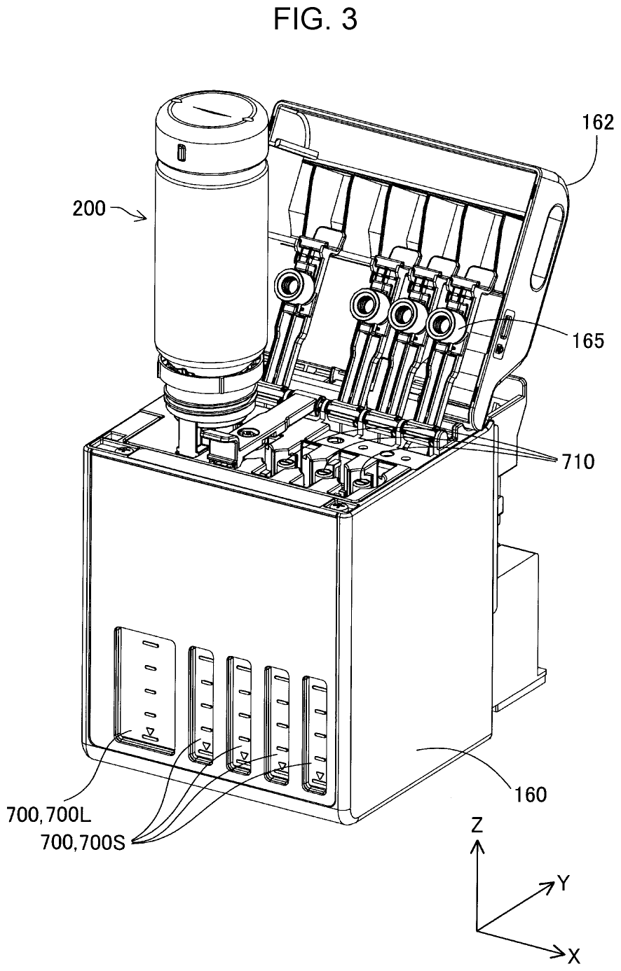

FIG. 3 is a perspective view showing a replenishment state in which the ink tank 700 is replenished with the ink from the ink replenishment container 200. A front surface of the ink tank 700 is formed of a transparent member. As a result, the remaining amount of ink in the ink tank 700 can be visually recognized from the outside. When the remaining amount of ink in the ink tank 700 decreases, the user can replenish the ink tank 700 with the ink from the ink introduction member 710 by opening the lid 162. In the present disclosure, “ink replenishment” means an operation of supplying ink to the ink tank 700 to increase the remaining amount of ink in the ink tank 700. However, it is not necessary to fill the ink tank 700 with the ink by the “ink replenishment”. The “ink replenishment” includes an operation of filling an empty ink tank 700 with ink when the printer 100 is used for the first time.

The ink tank accommodating unit 160 has a sealing cap 165 for sealing a tip end of the ink introduction member 710. When the ink tank 700 is not replenished with the ink, the tip end of the ink introduction member 710 is sealed with the sealing cap 165. When the ink tank 700 is replenished with the ink, the sealing cap 165 is removed from the ink introduction member 710, and a tip end portion of the ink replenishment container 200 is inserted into the position of the ink introduction member 710. As a result, the ink tank 700 is replenished with the ink.

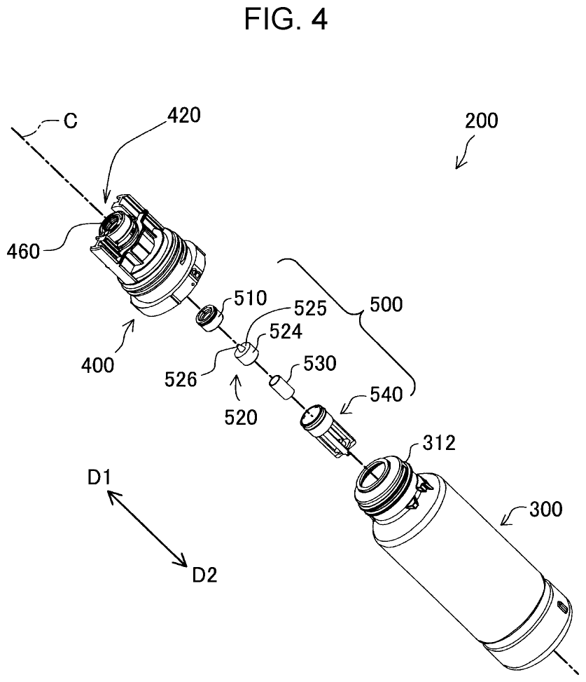

FIG. 4 is an exploded perspective view of the ink replenishment container 200. The ink replenishment container 200 is a container for replenishing the ink tank 700 with the ink by gas-liquid exchange. The ink replenishment container 200 includes a container main body 300, an ink outlet forming portion 400, and an outlet valve unit 500. The container main body 300 is configured to accommodate the ink. The container main body 300 is a hollow cylindrical container having an opening. An external thread 312 for attaching the ink outlet forming portion 400 is provided on an outer peripheral surface of the container main body 300 on the opening side. The ink outlet forming portion 400 is coupled to the container main body 300. The ink outlet forming portion 400 has a tubular portion 420 that forms an ink outlet 460 on the opposite side from the container main body 300. The outlet valve unit 500 is mounted in the ink outlet forming portion 400. The outlet valve unit 500 is a spring valve.

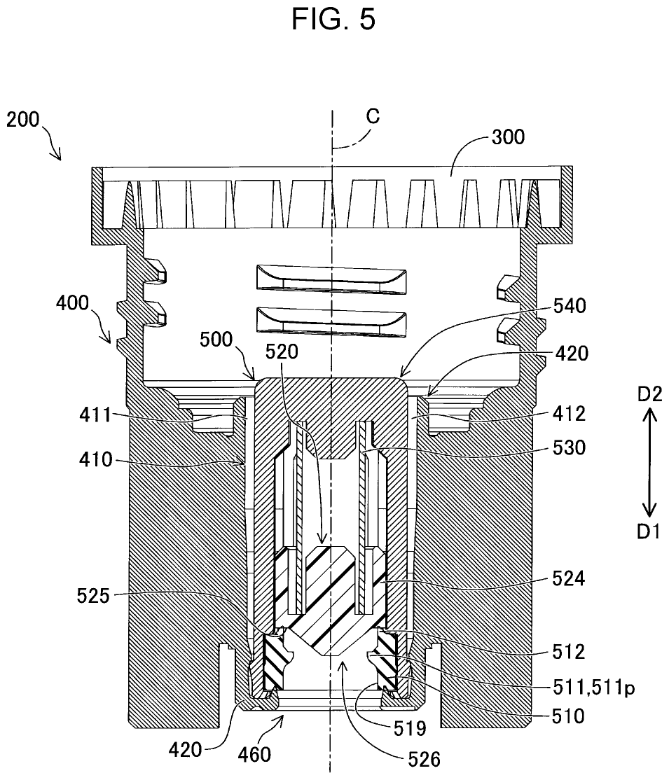

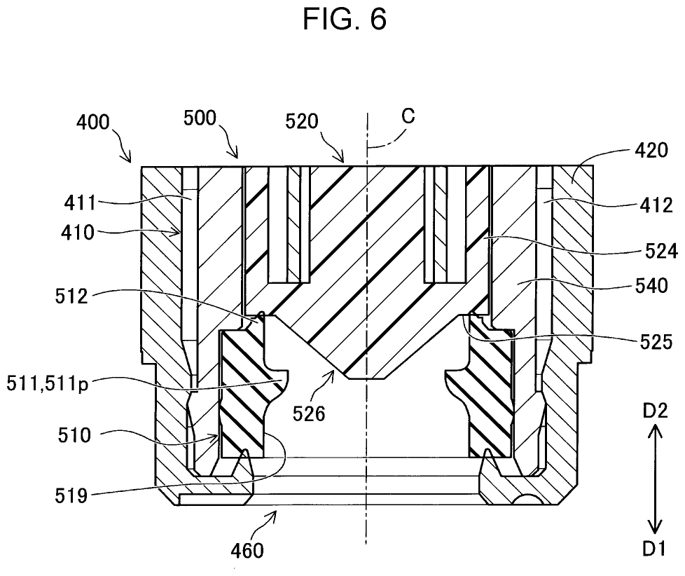

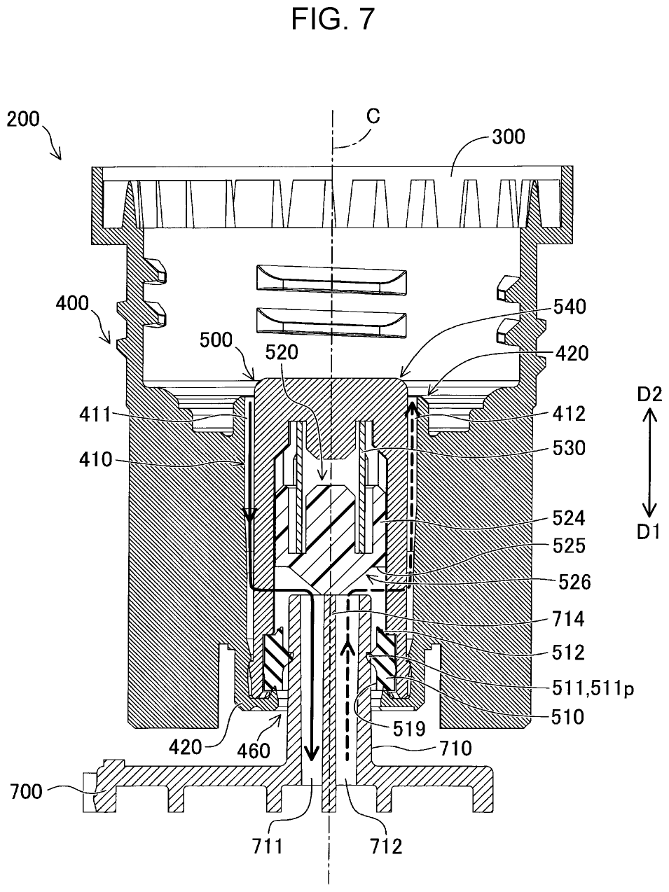

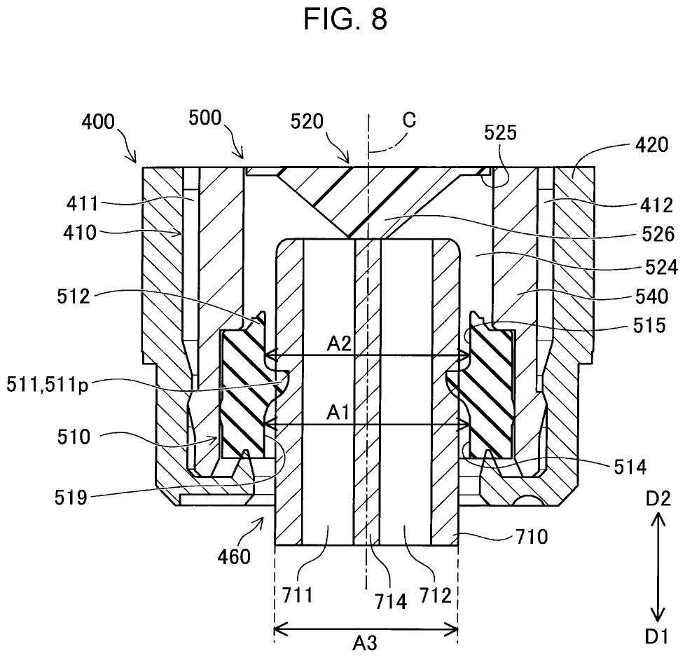

FIG. 5 is a partial sectional view of the ink replenishment container 200 in a non-replenishment state in which the ink tank 700 is not replenished with the ink. FIG. 5 shows a cross section obtained by cutting a part of the configuration of the ink replenishment container 200 along a central axis C of the tubular portion 420. FIG. 6 is an enlarged view of a part of FIG. 5. FIG. 7 is a partial sectional view of the ink replenishment container 200 and the ink tank 700 in a replenishment state in which the ink tank 700 is replenished with the ink. FIG. 7 shows a cross section obtained by cutting a part of the configuration of the ink replenishment container 200 and a part of the configuration of the ink introduction member 710 along the central axis C of the tubular portion 420. FIG. 8 is an enlarged view of a part of FIG. 7. In the following, the ink replenishment container 200 will be described with reference to FIGS. 4 to 8.

In this specification, a direction along the central axis C of the tubular portion 420 is referred to as a central axis direction. In addition, in the central axis direction, a direction from the container main body 300 toward the ink outlet 460 is referred to as a first direction D1, and a direction opposite to the first direction D1 is referred to as a second direction D2. Further, a direction toward the central axis C in a radial direction orthogonal to the central axis direction is referred to as a first radial direction D3.

As shown in FIGS. 5 and 6, in the non-replenishment state, the outlet valve unit 500 is in a valve-closed state in which the ink outlet 460 is sealed so that ink does not leak to the outside. As shown in FIGS. 7 and 8, in the replenishment state, the outlet valve unit 500 is in a valve-open state in which the sealing of the ink outlet 460 is released so that ink flows into the ink introduction member 710. The outlet valve unit 500 opens when the ink introduction member 710 is inserted into the tubular portion 420 from the ink outlet 460, and closes when the ink introduction member 710 is removed from the tubular portion 420. In FIGS. 7 and 8, although the ink introduction member 710 and a seal member 510 of the outlet valve unit 500 which will be described later are shown to interfere with each other, in practice, when the ink introduction member 710 is inserted into the tubular portion 420 from the ink outlet 460, the seal member 510 is deformed so as to come into contact with a side surface of the ink introduction member 710. The deformation of the seal member 510 will be described later.

As shown in FIGS. 5 and 7, the ink outlet forming portion 400 further includes a tubular flow path portion 410. As shown in FIG. 7, the ink introduction member 710 is inserted into the tubular flow path portion 410 via a through-hole 519 of the seal member 510, which will be described later, of the outlet valve unit 500. The tubular flow path portion 410 has a plurality of replenishment flow paths 411 and 412. In the present embodiment, the tubular flow path portion 410 has two replenishment flow paths 411 and 412. Each of the two replenishment flow paths 411 and 412 is formed by a gap between an inner peripheral surface of the tubular portion 420 and an outer peripheral surface of the outlet valve unit 500. One of the two replenishment flow paths 411 and 412 is used as an ink flow path, and the other is used as an air flow path. In FIG. 7, the solid line arrows indicate a flow of the ink, and the broken line arrows indicate a flow of air. In the present embodiment, a first replenishment flow path 411 is used as the ink flow path. A second replenishment flow path 412 is used as the air flow path.

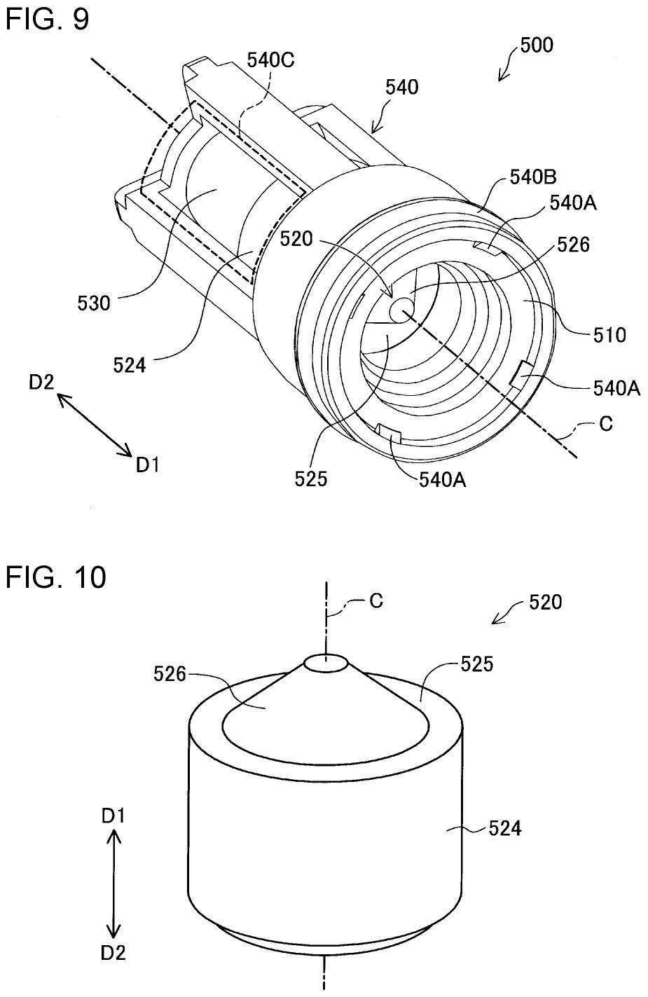

FIG. 9 is a perspective view of the outlet valve unit 500. As shown in FIGS. 9 and 4, the outlet valve unit 500 includes a valve housing 540, a valve body 520, a spring member 530, and the seal member 510 functioning as a valve seat.

The valve housing 540 accommodates the valve body 520, the spring member 530, and the seal member 510 therein. The valve housing 540 has a substantially cylindrical shape in which one end in the central axis direction is open and the other end in the central axis direction is closed. Here, the one end in the central axis direction is an end on the first direction D1 side, and the other end in the central axis direction is an end on the second direction D2 side. The ink introduction member 710 can be inserted into and pulled out from the valve housing 540 through an opening of the valve housing 540 formed at one end in the central axis direction. The valve housing 540 has a retaining portion 540A of the seal member 510 and an engaging portion 540B configured to be engaged with the tubular portion 420 on one end side in the central axis direction. As shown in FIG. 5, the valve housing 540 is mounted in the tubular portion 420. At this time, the gap forming the replenishment flow paths 411 and 412 is formed between the valve housing 540 and the tubular portion 420. The valve housing 540 has a side surface opening portion 540C, and in the valve-open state, the replenishment flow paths 411 and 412 communicate with the introduction flow paths 711 and 712, respectively, via the side surface opening portion 540C.

The valve body 520 is disposed to be movable in the central axis direction in the valve housing 540. The valve body 520 is formed of, for example, a thermoplastic resin such as polyethylene or polypropylene.

FIG. 10 is a view showing a configuration of the valve body 520. The valve body 520 has a cylindrical portion 524, a seal surface 525, and a protrusion 526.

The cylindrical portion 524 has a cylindrical shape extending in the central axis direction. As shown in FIG. 5, the cylindrical portion 524 faces an inner surface of the valve housing 540. The cylindrical portion 524 is guided by the inner surface of the valve housing 540 and is slidable in the central axis direction.

The seal surface 525 is formed on an end surface located on the first direction D1 side of the cylindrical portion 524. The seal surface 525 extends in a radial direction of the cylindrical portion 524 intersecting the central axis direction. The seal surface 525 has an annular shape when viewed along the central axis direction. As shown in FIG. 6, the seal surface 525 is in contact with a second seal portion 512 of the seal member 510, which will be described later, in the valve-closed state of the outlet valve unit 500.

The protrusion 526 is formed inside the seal surface 525 in the radial direction of the cylindrical portion 524. As shown in FIG. 5, the protrusion 526 is located further on the ink outlet 460 side than the seal surface 525 in the central axis direction. The shape of the protrusion 526 is a truncated conical shape in which a cross-sectional area in the radial direction orthogonal to the central axis direction is larger on the second direction D2 side than on the first direction D1 side. As shown in FIG. 8, a tip end of the protrusion 526 is in contact with the partition 714 of the ink introduction member 710 in the valve-open state of the outlet valve unit 500.

As shown in FIG. 5, the spring member 530 biases the valve body 520 in the first direction D1. The spring member 530 is accommodated in the valve housing 540 and is supported by the valve housing 540. The spring member 530 is formed of, for example, metal. In the present embodiment, the spring member 530 is a coil spring.

The seal member 510 is mounted inside the valve housing 540. The seal member 510 is located further on the ink outlet 460 side than the valve body 520 in the central axis direction. The shape of the seal member 510 is a substantially ring-shape. The seal member 510 is formed of, for example, an elastic rubber member or an elastomer. The seal member 510 has a through-hole 519 through which the ink introduction member 710 is inserted and pulled out. The through-hole 519 is formed by an inner peripheral surface of the seal member 510.

The seal member 510 further includes a first seal portion 511 and the second seal portion 512. The first seal portion 511 is formed on the inner peripheral surface of the seal member 510, and comes into contact with the side surface of the ink introduction member 710 inserted into the through-hole 519 in the valve-open state to seal the side surface of the ink introduction member 710. Details of the first seal portion 511 will be described later.

The second seal portion 512 protrudes toward the seal surface 525 of the valve body 520 along the central axis C of the tubular portion 420. The second seal portion 512 switches communication between the replenishment flow paths 411 and 412 and the introduction flow paths 711 and 712. As shown in FIGS. 5 and 6, in the valve-closed state of the outlet valve unit 500, the valve body 520 is biased by the spring member 530 toward the seal member 510 located further on the ink outlet 460 side than the valve body 520. The second seal portion 512 closes the through-hole 519 by being in contact with the seal surface 525 of the valve body 520 in the valve-closed state of the outlet valve unit 500 by the biasing of the spring member 530. As a result, the second seal portion 512 blocks the communication between the replenishment flow paths 411 and 412 and the introduction flow paths 711 and 712. On the other hand, as shown in FIGS. 7 and 8, the ink introduction member 710 is inserted into the tubular portion 420 from the ink outlet 460 and the valve body 520 is pressed in the second direction D2. Accordingly, the second seal portion 512 is separated from the seal surface 525 of the valve body 520. As a result, a gap is formed between the second seal portion 512 and the valve body 520 in the valve-open state of the outlet valve unit 500. In other words, in the valve-open state of the outlet valve unit 500, the ink introduction member 710 is inserted through the through-hole 519 and presses the valve body 520 in the second direction D2. Accordingly, a gap through which the ink and air flow is formed between the seal member 510 and the valve body 520. In addition, in the valve-closed state of the outlet valve unit 500, the ink introduction member 710 is removed through the through-hole 519, and thus the valve body 520 comes into contact with the seal member 510 and the through-hole 519 is closed.

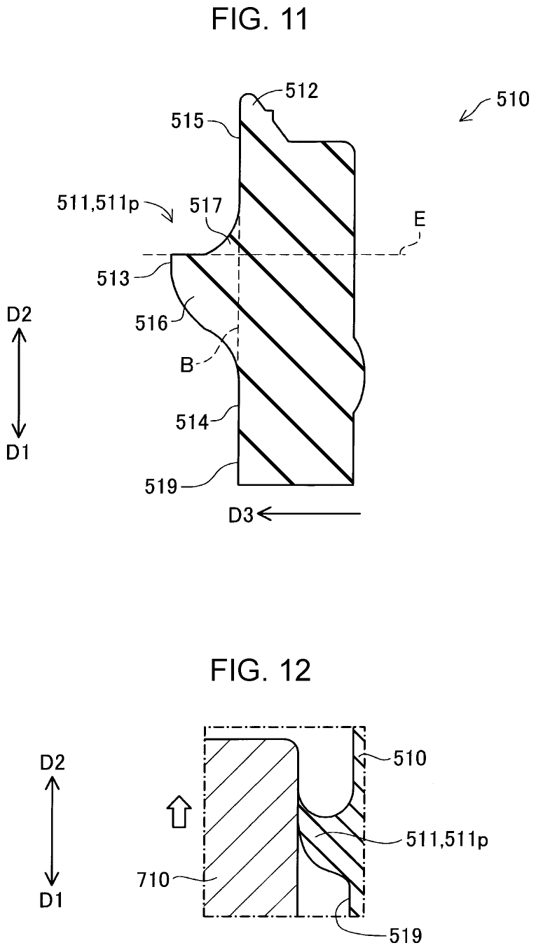

FIG. 11 is a view showing a part of a cross section of the seal member 510 cut along the central axis C of the tubular portion 420. As shown in FIG. 11, the first seal portion 511 is an annular protruding portion 511p having a minimum inner diameter portion 513 in the first radial direction D3. Here, the minimum inner diameter portion 513 is a portion where a diameter of the inner peripheral surface of the seal member 510 is the smallest. In the present embodiment, the minimum inner diameter portion 513 has a length along the central axis direction. That is, in the seal member 510, a portion having the minimum inner diameter exists in a certain range along the central axis direction. Hereinafter, of the inner peripheral surfaces of the seal member 510, the inner peripheral surface located further on the first direction D1 side than the protruding portion 511p is referred to as a first direction-side inner peripheral surface 514, and the inner peripheral surface located further on the second direction D2 side than the protruding portion 511p is referred to as a second direction-side inner peripheral surface 515. The protruding portion 511p has a height from the second direction-side inner peripheral surface 515 to the minimum inner diameter portion 513, which is a height along the first radial direction D3. That is, the protruding portion 511p is a portion that protrudes toward the first radial direction D3 side compared to the second direction-side inner peripheral surface 515. In FIG. 11, a portion existing on the first radial direction D3 side with respect to a boundary B along the second direction-side inner peripheral surface 515 is the protruding portion 511p.

The first direction-side inner peripheral surface 514 is a portion of the inner peripheral surface located further on the first direction D1 side than the protruding portion 511p. The diameter is substantially constant in the first direction-side inner peripheral surface 514 regardless of the position in the central axis direction. The second direction-side inner peripheral surface 515 is a portion of the inner peripheral surface located further on the second direction D2 side than the protruding portion 511p. The diameter is substantially constant in the second direction-side inner peripheral surface 515 regardless of the position in the central axis direction. As shown in FIG. 8, a diameter A2 of the second direction-side inner peripheral surface 515 is equal to a diameter A1 of the first direction-side inner peripheral surface 514. The diameter A2 of the second direction-side inner peripheral surface 515 is 1.1 times or more a diameter A3 of the outer peripheral surface of the ink introduction member 710.

Hereinafter, as shown in FIG. 11, in the protruding portion 511p, a position of an end portion of the minimum inner diameter portion 513 in the second direction D2 is defined as a boundary E, a portion located on the first direction D1 side with respect to the boundary E is referred to as an outlet-side portion 516, and a portion located on the second direction D2 side with respect to the boundary E is referred to as a valve body-side portion 517. An inner surface of the valve body-side portion 517, that is, a portion of the inner peripheral surface of the seal member 510, which constitutes the valve body-side portion 517, is a concave arc surface in a cross section along the central axis direction. An inner surface of the outlet-side portion 516, that is, a portion of the inner peripheral surface of the seal member 510, which constitutes the outlet-side portion 516, is a convex arc surface in a cross section along the central axis direction. The seal member 510 is formed such that a volume of the valve body-side portion 517 is smaller than a volume of the outlet-side portion 516.

FIG. 12 is a view for describing deformation of the first seal portion 511 when the ink introduction member 710 is inserted into the through-hole 519. When the ink introduction member 710 is inserted into the through-hole 519, the first seal portion 511 receives, from the ink introduction member 710, force toward the second direction D2. Thus, the first seal portion 511 is deformed such that the position of the minimum inner diameter portion 513 moves in the second direction D2.

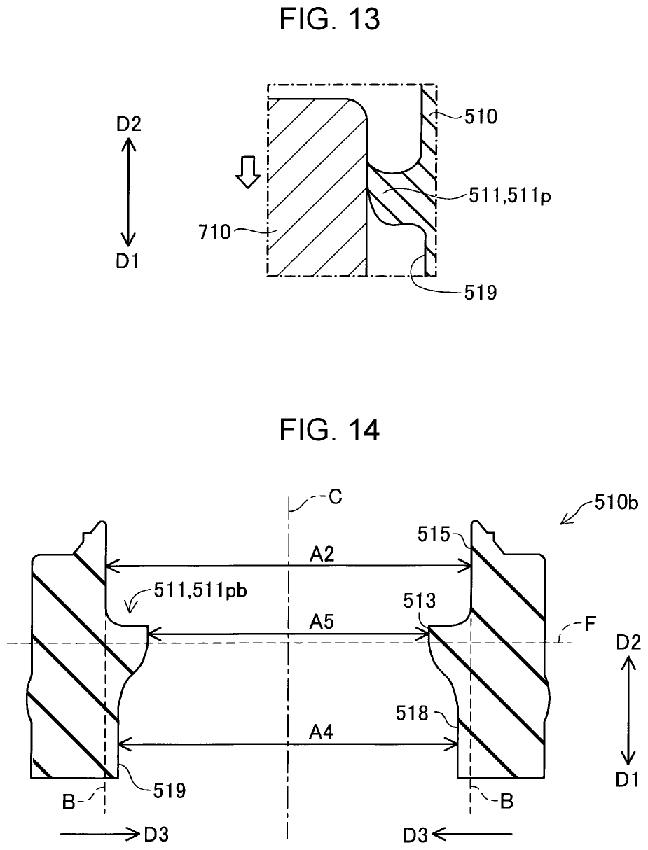

FIG. 13 is a view for describing deformation of the first seal portion 511 when the ink introduction member 710 is removed from the through-hole 519. When the ink introduction member 710 is removed from the through-hole 519, the first seal portion 511 receives, from the ink introduction member 710, force toward the first direction D1. Thus, the first seal portion 511 is deformed such that the position of the minimum inner diameter portion 513 moves in the first direction D1.

According to the first embodiment described above, the seal member 510 of the ink replenishment container 200 is formed such that the volume of the valve body-side portion 517 is smaller than the volume of the outlet-side portion 516. In other words, the valve body-side portion 517 is formed so as to be thinner than the outlet-side portion 516. Therefore, the valve body-side portion 517 is more easily deformed than the outlet-side portion 516. When the ink introduction member 710 is inserted into the through-hole 519, the first seal portion 511 receives, from the ink introduction member 710, force toward the second direction D2. Therefore, as compared with a case where the volume of the valve body-side portion 517 is larger than the volume of the outlet-side portion 516 or a case where the volume of the valve body-side portion 517 is equal to the volume of the outlet-side portion 516, in the present embodiment, the load at the time of coupling the ink replenishment container 200 to the ink introduction member 710 becomes small. Therefore, the ink replenishment container 200 can be easily coupled to the ink introduction member 710.

In addition, when the ink introduction member 710 is removed from the through-hole 519, the first seal portion 511 receives, from the ink introduction member 710, force toward the first direction D1. Therefore, as compared with a case where the volume of the valve body-side portion 517 is larger than the volume of the outlet-side portion 516 or a case where the volume of the valve body-side portion 517 is equal to the volume of the outlet-side portion 516, in the present embodiment, the load at the time of removing the ink replenishment container 200 from the ink introduction member 710 increases. Therefore, the ink replenishment container 200 is less likely to be removed from the ink introduction member 710. When the load at the time of removing the ink replenishment container 200 from the ink introduction member 710 is small, the ink replenishment container 200 in the replenishment state easily moves in the second direction D2 due to the reaction force of the spring member 530, which may cause ink leakage to the outside. In the present embodiment, since the load at the time of removing the ink replenishment container 200 from the ink introduction member 710 is large, the ink replenishment container 200 does not easily move in the second direction D2, and the replenishment state can be stably maintained. For this reason, the ink replenishment is appropriately performed.

In addition, in the present embodiment, a diameter of the second direction-side inner peripheral surface 515 is 1.1 times or more a diameter of the outer peripheral surface of the ink introduction member 710. Therefore, when the ink introduction member 710 is inserted into the ink replenishment container 200 via the through-hole 519 of the seal member 510, an increase in the load can be reduced even after the ink introduction member 710 has passed through the first seal portion 511. When the diameter of the second direction-side inner peripheral surface 515 is less than 1.1 times the diameter of the ink introduction member 710, a gap between the second direction-side inner peripheral surface 515 and the outer periphery of the ink introduction member 710 becomes narrow. Therefore, when the ink introduction member 710 is obliquely inserted into the through-hole 519 of the seal member 510, the ink introduction member 710 that has passed through the first seal portion 511 comes into contact with the second direction-side inner peripheral surface 515, thereby restricting the deformation of the first seal portion 511 and increasing the insertion load. In the present embodiment, since it is difficult for the ink introduction member 710 that has passed through the first seal portion 511 to come into contact with the second direction-side inner peripheral surface 515, an increase in the insertion load can be reduced, and the ink introduction member 710 can be easily inserted deeply into a position inside the ink replenishment container 200.

Further, in the present embodiment, the diameter of the second direction-side inner peripheral surface 515 is equal to the diameter of the first direction-side inner peripheral surface 514. Therefore, as compared with a case where the diameter of the second direction-side inner peripheral surface 515 is smaller than the diameter of the first direction-side inner peripheral surface 514, when the ink introduction member 710 is inserted into the ink replenishment container 200 via the through-hole 519 of the seal member 510, the ink introduction member 710 that has passed through the first seal portion 511 can be made less likely to contact the second direction-side inner peripheral surface 515. Therefore, an increase in the insertion load can be reduced, and the ink introduction member 710 can be easily inserted deeply into a position inside the ink replenishment container 200.

### B. Second Embodiment

FIG. 14 is a view for describing a shape of a seal member 510b in a second embodiment. In the second embodiment, the shape of the seal member 510b is different from that in the first embodiment. The configuration of each portion of the ink replenishment container 200 other than the seal member 510b is the same as that of the first embodiment.

FIG. 14 shows a cross section of the seal member 510b cut along the central axis C of the tubular portion 420. As described above, the protruding portion 511pb is a portion that protrudes toward the first radial direction D3 side compared to the second direction-side inner peripheral surface 515. That is, the protruding portion 511pb is a portion that protrudes from the boundary B along the second direction-side inner peripheral surface 515 toward the first radial direction D3. In the second embodiment, the entire portion of the inner peripheral surface of the seal member 510b, which is located further on the first direction D1 side than the second direction-side inner peripheral surface 515, protrudes from the boundary B in the first radial direction D3. In other words, the entire portion located further on the first direction D1 side than the second direction-side inner peripheral surface 515 serves as the protruding portion 511pb. Therefore, the seal member 510b does not have the first direction-side inner peripheral surface 514. As a result, it can be said that the protruding portion 511pb is formed at the end portion of the seal member 510b on the first direction D1 side. The protruding portion 511pb has a protruding portion inner peripheral surface 518 located on the first direction D1 side with respect to an end portion F of the minimum inner diameter portion 513 in the first direction D1. The protruding portion inner peripheral surface 518 is a portion of the inner peripheral surface of the protruding portion 511pb, which is located further on the first direction D1 side than the minimum inner diameter portion 513. The diameter is substantially constant in the protruding portion inner peripheral surface 518 regardless of the position in the central axis direction. A diameter A4 of the protruding portion inner peripheral surface 518 is larger than a diameter A5 of the minimum inner diameter portion 513 and is smaller than the diameter A2 of the second direction-side inner peripheral surface 515.

According to the second embodiment described above, since the diameter A2 of the second direction-side inner peripheral surface 515 is larger than the diameter A4 of the protruding portion inner peripheral surface 518, when the ink introduction member 710 is inserted into the ink replenishment container 200 via the through-hole 519 of the seal member 510b, the ink introduction member 710 that has passed through the first seal portion 511 can be made less likely to contact the second direction-side inner peripheral surface 515. Therefore, an increase in the insertion load can be suppressed, and the ink introduction member 710 can be easily inserted deeply into a position inside the ink replenishment container 200.

### C. Other Embodiments

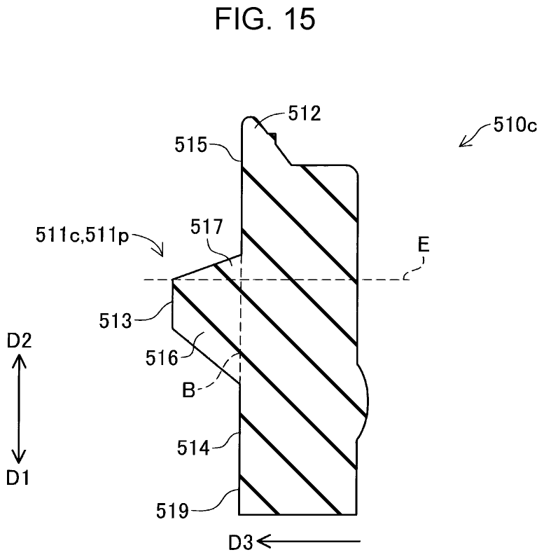

C-1. In the above embodiments, the inner surface of the valve body-side portion 517 is a concave arc surface in a cross section along the central axis direction. Further, the inner surface of the outlet-side portion 516 is a convex arc surface in a cross section along the central axis direction. On the other hand, as shown in FIG. 15, a shape of a first seal portion 511c cut along the central axis C of the tubular portion 420 may be a trapezoidal shape in which a length in a direction along the central axis direction is larger on the side farther from the central axis C than on the side closer to the central axis C in the radial direction. FIG. 15 shows a part of a cross section of the seal member 510c cut along the central axis C of the tubular portion 420.

C-2. In the above embodiments, the minimum inner diameter portion 513 has a length along the central axis direction. On the other hand, the minimum inner diameter portion 513 may be one point. That is, the diameter of the inner peripheral surface of the protruding portion 511p may be the smallest at one point in the central axis direction.

C-3. In the above embodiments, the diameter A2 of the second direction-side inner peripheral surface 515 is 1.1 times or more the diameter A3 of the outer peripheral surface of the ink introduction member 710. On the other hand, the diameter A2 of the second direction-side inner peripheral surface 515 may be less than 1.1 times the diameter A3 of the outer peripheral surface of the ink introduction member 710.

C-4. In the above embodiments, the outlet-side portion 516 is a portion of the protruding portion 511p, which is located on the first direction D1 side with respect to the boundary E, and the valve body-side portion 517 is a portion located on the second direction D2 side with respect to the boundary E. On the other hand, the outlet-side portion 516 may be a portion of the protruding portion 511p in a portion that interferes with the ink introduction member 710 inserted into the through-hole 519, which is located on the first direction D1 side with respect to the boundary E. In addition, the valve body-side portion 517 may be a portion of the protruding portion 511p, in the portion that interferes with the ink introduction member 710 inserted into the through-hole 519, which is located on the second direction D2 side with respect to the boundary E.

C-5. In the first embodiment, the seal member 510 has the first direction-side inner peripheral surface 514. In contrast, in the first embodiment, the seal member 510 does not necessarily have the first direction-side inner peripheral surface 514. That is, the first seal portion 511 may be formed at the end portion of the seal member 510 on the first direction D1 side.

C-6. In the first embodiment, the diameter A2 of the second direction-side inner peripheral surface 515 is equal to the diameter A1 of the first direction-side inner peripheral surface 514. In contrast, in the first embodiment, the diameter A2 of the second direction-side inner peripheral surface 515 may be smaller than the diameter A1 of the first direction-side inner peripheral surface 514.

### D. Other Embodiments

The present disclosure is not limited to the above-described embodiments, and can be realized in various aspects without departing from the gist of the present disclosure. For example, the present disclosure can also be realized in the following aspects. Technical features in the above-described embodiments corresponding to technical features in each aspect described below can be appropriately replaced or combined in order to solve some or all of the problems of the present disclosure, or in order to achieve some or all of the effects of the present disclosure. In addition, unless the technical features are described as essential in the present specification, the technical features can be deleted as appropriate.

(1) According to a first aspect of the present disclosure, an ink replenishment container is provided. The ink replenishment container replenishes an ink tank of a printer with ink via an ink introduction member communicating with the ink tank. The ink replenishment container includes a container main body configured to accommodate the ink, an ink outlet forming portion connected to the container main body and including a tubular portion forming an outlet on an opposite side from the container main body, and an outlet valve unit mounted in the ink outlet forming portion and configured to be opened by the ink introduction member inserted into the tubular portion from the outlet and to be closed by removal of the ink introduction member from the tubular portion. The outlet valve unit includes a valve body disposed to be movable in a central axis direction along a central axis of the tubular portion, a spring member configured to bias the valve body in a first direction toward the outlet side in the central axis direction, and a seal member located on the outlet side from the valve body in the central axis direction, the seal member having a through-hole through which the ink introduction member is inserted and removed, in a valve-opened state, a gap through which the ink and the air communicate being formed between the seal member and the valve body that is pressed by the ink introduction member, which is inserted through the through-hole, in a second direction opposite to the first direction, in a valve-closed state, the valve body being in contact with the sealing member and the through-hole being closed by removal of the ink introduction member through the through-hole. The seal member includes a first seal portion on an inner peripheral surface forming the through-hole, the first seal portion being at least partially in contact with a side surface of the ink introduction member inserted into the through-hole in the valve-opened state to seal the side surface of the ink introduction member. The first seal portion is an annular protruding portion having a minimum inner diameter portion in a first radial direction toward the central axis, in a radial direction orthogonal to the central axis direction. The protruding portion has a height from a second direction-side inner peripheral surface of the inner peripheral surface to the minimum inner diameter portion in the first radial direction, the second direction-side inner peripheral surface located on the second direction side from the protruding portion. The seal member is formed such that in the protruding portion a volume of a valve body-side portion is smaller than a volume of an outlet-side portion, the valve body-side portion being a portion located on the second direction side with respect to a boundary, the outlet-side portion being a portion located on the first direction side with respect to the boundary, the boundary being a position of an end portion of the minimum inner diameter portion in the second direction.

According to such an aspect, since the valve body-side portion is more easily deformed than the outlet-side portion, as compared with a case where the volume of the valve body-side portion is larger than the volume of the outlet-side portion or a case where the volume of the valve body-side portion is equal to the volume of the outlet-side portion, the load at the time of coupling the ink replenishment container to the ink introduction member becomes small. Therefore, the ink replenishment container can be easily coupled to the ink introduction member.

(2) In the above aspect, the diameter of the second direction-side inner peripheral surface is 1.1 times or more the diameter of the outer peripheral surface of the ink introduction member.

According to such an aspect, when the ink introduction member is inserted into the ink replenishment container via the through-hole of the seal member, an increase in the load can be reduced even after the ink introduction member has passed through the first seal portion. Therefore, the ink replenishment container can be easily coupled to the ink introduction member.

(3) In the above aspect, the inner peripheral surface further includes a first direction-side inner peripheral surface located on the first direction side from the protruding portion, and a diameter of the second direction-side inner peripheral surface is equal to a diameter of the first direction-side inner peripheral surface.

According to such an aspect, as compared with a case where the diameter of the second direction-side inner peripheral surface is smaller than the diameter of the first direction-side inner peripheral surface, when the ink introduction member is inserted into the ink replenishment container via the through-hole of the seal member, the ink introduction member that has passed through the first seal portion can be made less likely to contact the second direction-side inner peripheral surface. Therefore, an increase in the insertion load can be reduced, and the ink introduction member can be easily inserted deeply into a position inside the ink replenishment container.

(4) In the above aspect, the protruding portion may include a protruding portion inner peripheral surface located on the first direction side with respect to an end portion of the minimum inner diameter portion in the first direction, and a diameter of the protruding portion inner peripheral surface may be larger than a diameter of the minimum inner diameter portion and is smaller than a diameter of the second direction-side inner peripheral surface.

According to such an aspect, as compared with a case where the diameter of the second direction-side inner peripheral surface is smaller than the diameter of the protruding portion inner peripheral surface, when the ink introduction member is inserted into the ink replenishment container via the through-hole of the seal member, the ink introduction member that has passed through the first seal portion can be made less likely to contact the second direction-side inner peripheral surface. Therefore, an increase in the insertion load can be reduced, and the ink introduction member can be easily inserted deeply into a position inside the ink replenishment container.

What is claimed is:

1. An ink replenishment container that replenishes an ink tank of a printer with ink via an ink introduction member communicating with the ink tank, the ink replenishment container comprising:
a container main body configured to accommodate the ink;
an ink outlet forming portion connected to the container main body and including a tubular portion forming an outlet on an opposite side from the container main body; and
an outlet valve unit mounted in the ink outlet forming portion and configured to be opened by the ink introduction member inserted into the tubular portion from the outlet and to be closed by removal of the ink introduction member from the tubular portion; wherein
the outlet valve unit includes
a valve body disposed to be movable in a central axis direction along a central axis of the tubular portion,
a spring member configured to bias the valve body in a first direction toward the outlet side in the central axis direction, and
a seal member located on the outlet side from the valve body in the central axis direction, the seal member having a through-hole through which the ink introduction member is inserted and removed,
in a valve-opened state, a gap through which the ink and the air communicate being formed between the seal member and the valve body that is pressed by the ink introduction member, which is inserted through the through-hole, in a second direction opposite to the first direction,
in a valve-closed state, the valve body being in contact with the sealing member and the through-hole being closed by removal of the ink introduction member through the through-hole,
wherein
the seal member includes a first seal portion on an inner peripheral surface forming the through-hole, the first seal portion being at least partially in contact with a side surface of the ink introduction member inserted into the through-hole in the valve-opened state to seal the side surface of the ink introduction member,
the first seal portion is an annular protruding portion having a minimum inner diameter portion in a first radial direction toward the central axis, in a radial direction orthogonal to the central axis direction,
the protruding portion has a height from a second direction-side inner peripheral surface of the inner peripheral surface to the minimum inner diameter portion in the first radial direction, the second direction-side inner peripheral surface located on the second direction side from the protruding portion, and
the seal member is formed such that in the protruding portion a volume of a valve body-side portion is smaller than a volume of an outlet-side portion, the valve body-side portion being a portion located on the second direction side with respect to a boundary, the outlet-side portion being a portion located on the first direction side with respect to the boundary, the boundary being a position of an end portion of the minimum inner diameter portion in the second direction.

2. The ink replenishment container according to claim 1, wherein
a diameter of the second direction-side inner peripheral surface is 1.1 times or more a diameter of an outer peripheral surface of the ink introduction member.

3. The ink replenishment container according to claim 1, wherein
the inner peripheral surface further includes a first direction-side inner peripheral surface located on the first direction side from the protruding portion, and
a diameter of the second direction-side inner peripheral surface is equal to a diameter of the first direction-side inner peripheral surface.

4. The ink replenishment container according to claim 1, wherein
the protruding portion includes a protruding portion inner peripheral surface located on the first direction side with respect to an end portion of the minimum inner diameter portion in the first direction, and
a diameter of the protruding portion inner peripheral surface is larger than a diameter of the minimum inner diameter portion and is smaller than a diameter of the second direction-side inner peripheral surface.
